(19) United States
(12) Patent Application Publication
(10) Pub. No.: US 2026/0267640 A1
(43) Pub. Date: Sep. 10, 2026

(54) INFORMATION PROCESSING METHOD, INFORMATION PROCESSING ARCHITECTURE, AND PROGRAM

(71) Applicant: THE UNIVERSITY OF TOKYO, Tokyo (JP)

(72) Inventors: Hidetsugu IRIE, Tokyo (JP); Takumi HIRAOKA, Tokyo (JP); Toru KOIZUMI, Tokyo (JP); Shuichi SAKAI, Tokyo (JP); Shu SUGITA, Tokyo (JP)

(21) Appl. No.: 19/164,681

(22) PCT Filed: Mar. 12, 2024
(86) PCT No.: PCT/JP2024/009586

§ 371 Date: Dec. 3, 2025

(30) Foreign Application Priority Data
Mar. 14, 2023 (JP) 2023-039596

(51) Int. Cl. G06F 9/30

(52) U.S. Cl. CPC G06F 9/30007; G06F 9/30094

(57) ABSTRACT

An information processing method based on a command system is provided. The command system in the information processing method includes a command in which a relative position referring to a past execution result serves as an operand. The information processing method comprises the following steps. In an acquisition step, an operand related to a repeat command included in the command system is acquired. In an execution step, an operation corresponding to a predetermined command is repeatedly executed on the basis of the acquired operand. The operand includes a first operand indicating the number of repetitions of the predetermined command, and a second operand indicating a stride of a register of the predetermined command.

### BACKGROUND

### Technical Field

The present disclosure relates to an information processing method, an information processing architecture, and a program.

### Related Art

Patent Document 1 discloses an assembly instruction conversion program. This assembly instruction conversion program causes a computer to store, in a storage area, a plurality of generation instructions for instructing the generation of machine codes of second assembly instructions that perform processing equivalent to first assembly instructions, for each of the plurality of first assembly instructions, and to execute processing that generates the machine codes in accordance with the plurality of generation instructions in the storage area such that the machine codes of the plurality of the second assembly instructions having dependencies are not consecutive.

### PRIOR ART DOCUMENTS

### Patent Document

[Patent Document 1] JP2021-184246 A

However, even in consideration of prior art, there is room for improvement, for example, in suppressing the complexity of decoding.

In view of the above circumstances, the present disclosure provides a more useful technique.

### SUMMARY

According to one aspect of the present disclosure, there is provided an information processing method based on an instruction set. The instruction set according to this information processing method includes an instruction that uses, as an operand, a relative position that refers to a past execution result. The information processing method includes the following steps. In an acquisition step, operands relating to a repeat instruction included in the instruction set are acquired. In an execution step, an operation corresponding to a predetermined instruction is repeatedly executed based on the acquired operands. The operands include a first operand indicating a number of repetitions of the predetermined instruction, and a second operand indicating a stride of a register of the predetermined instruction.

According to such an aspect, it is possible to provide a more useful technique.

### BRIEF DESCRIPTION OF THE DRAWINGS

FIG. 1 is a configuration diagram illustrating a hardware configuration of an information processing system 1 according to one embodiment.

FIG. 2A and FIG. 2B are block diagrams each illustrating details of FIG. 1, in particular, FIG. 2A illustrates a configuration of a server apparatus 2, and FIG. 2B illustrates a configuration of a terminal apparatus 3.

FIG. 3 is a flowchart showing an overview of an information processing method according to one embodiment.

FIG. 4 is a schematic diagram showing an example of an instruction format of a repeat instruction.

FIG. 5 shows an example of source code using a repeat instruction, and particularly shows a base reference that refers to the same register in each line of an instruction sequence.

FIG. 6 shows an example of source code using a repeat instruction, and particularly shows an incremental parallel reference in which a stride of a register is zero and a reference distance is greater than or equal to a repeat count.

FIG. 7 shows an example of source code using a repeat instruction, and particularly shows an incremental dependent reference in which a stride of a register is zero and a reference distance is less than a repeat count.

FIG. 8A and FIG. 8B are schematic diagrams for explaining a vertical vector execution method, FIG. 8A shows a conventional general vector instruction, and FIG. 8B shows a vertical vector execution method.

FIG. 9 is a schematic diagram showing a flow of compilation.

### DETAILED DESCRIPTION

Hereinafter, an embodiment of the present disclosure will be described with reference to drawings. Various features described in the embodiment below can be combined with each other.

A program for implementing a software described in one embodiment may be provided as a non-transitory computer-readable storage medium, may be made available for download from an external server, or may be provided in such a manner that the program can be activated on an external computer to implement functions thereof on a client terminal (so-called cloud computing).

In various types of information processing according to one embodiment, an input and an output corresponding to the input can be realized. Here, as long as an output is obtained as a result of the input, the form of information referred to in such information processing (hereinafter referred to as reference information) is not limited. The reference information may be, for example, rule-based information such as a database, a look-up table, a predefined function (including a decision formula such as a regression equation constructed by statistical methods), may be a trained model in which the correlation between an input and an output has been learned in advance, or may be a large-scale language model capable of outputting a desired result by inputting a prompt.

In one embodiment, the term “unit” may also include, for example, a combination of hardware resources implemented by a circuit in a broad sense, and information processing performed by software that may be specifically implemented by such hardware resources. Furthermore, various kinds of information are handled in one embodiment, and such information may be represented by, for example, physical values of signal values representing voltage and current, high and low signal values as a set of binary bits consisting of 0 or 1, or quantum superposition (so-called qubits), and communication and computation may be executed on a circuit in a broad sense.

Furthermore, the term “circuit in a broad sense” refers to a circuit that is implemented by appropriately combining at least one or more of a circuit, circuitry, a processor, memory, and the like. In other words, the term “circuit in a broad sense” includes an application specific integrated circuit (ASIC), a programmable logic device (e.g., a simple programmable logic device (SPLD), a complex programmable logic device (CPLD), a field programmable gate array (FPGA)), and the like.

### Embodiment

### 1. Hardware Configuration

This section will describe a hardware configuration according to one embodiment.

### 1.1 Information Processing System 1

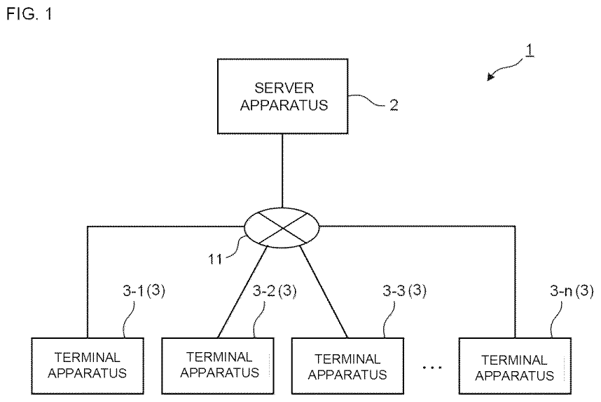

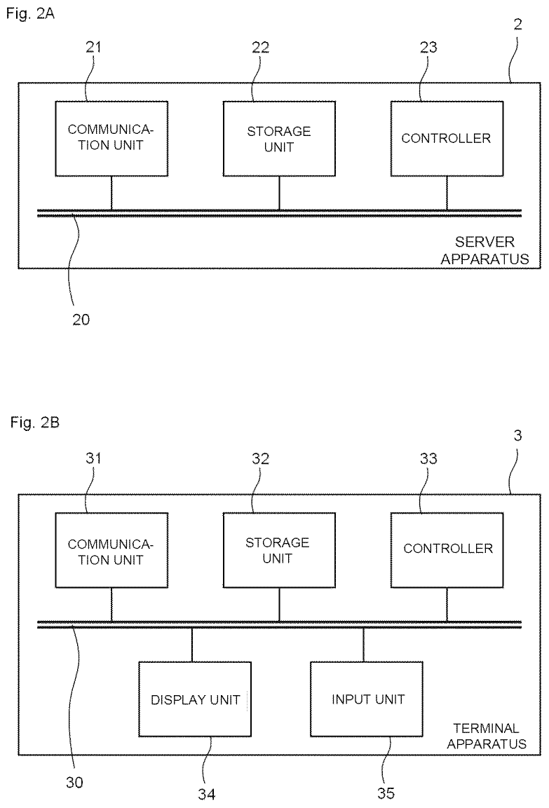

FIG. 1 is a configuration diagram illustrating a hardware configuration of an information processing system 1 according to one embodiment. In addition, FIG. 2A and FIG. 2B are block diagrams each illustrating details of FIG. 1, in particular, FIG. 2A illustrates a configuration of a server apparatus 2, and FIG. 2B illustrates a configuration of a terminal apparatus 3. The information processing system 1 includes, for example, the server apparatus 2, and a plurality of terminal apparatuses 3, which are electrically connected to each other. These components will be described further. Here, the system exemplified by the information processing system 1 is composed of one or more apparatuses or components. Accordingly, it should be noted that even the single server apparatus 2, or a combination of the server apparatus 2 and the terminal apparatus 3, is included in the information processing system 1. More specifically, the information processing system 1 may include an element selected from a group consisting of the server apparatus 2 and the terminal apparatus 3. An element that is not selected is not necessarily included in the information processing system 1, but is electrically connected to the selected element as an external element. Furthermore, the information processing architecture may be the information processing system 1, may be the server apparatus 2, may be the terminal apparatus 3, or may be a circuit in a broad sense provided in any of these.

### 1.2 Server Apparatus 2

As shown in FIG. 2A, the server apparatus 2 includes a communication unit 21, a storage unit 22, and a controller 23. These components are electrically connected via a communication bus 20 inside the server apparatus 2. Each of the components will be described further below.

It is preferable for the communication unit 21 to include wired communication means such as USB, IEEE 1394, Thunderbolt (registered trademark), and wired LAN network communication. The communication unit 21 may also include wireless LAN network communication, mobile communication such as 3G/LTE/5G, and BLUETOOTH (registered trademark) communication as necessary. That is, it is more preferable to implement the communication unit 21 as a set of these multiple types of communication means. In other words, the server apparatus 2 may communicate various types of information with an external device via the communication unit 21 and a network.

The storage unit 22 stores the above-defined various kinds of information. The storage unit 22 may be implemented, for example, as a storage device such as a solid state drive (SSD) storing various programs, etc. pertaining to the server apparatus 2 and executed by the controller 23, or as a memory such as a random access memory (RAM) storing temporarily necessary information (argument, array, or the like) pertaining to program operations. The storage unit 22 stores various programs, variables, etc. pertaining to the server apparatus 2 and executed by the controller 23.

The controller 23 processes and controls overall operation pertaining to the server apparatus 2. The controller 23 is, for example, an unshown central processing unit (CPU). The controller 23 implements various functions pertaining to the server apparatus 2 by reading a predetermined program stored in the storage unit 22. In other words, information processing by software stored in the storage unit 22 is specifically realized by the controller 23 as an example of hardware, and can be executed as each function execution unit included in the controller 23. Note that the controller 23 is not limited to being a single controller but may be implemented with a plurality of controllers 23 for each function. Moreover, a combination thereof may be applied.

### 1.3 Terminal Apparatus 3

The information processing system 1 includes a plurality of terminal apparatuses 3. For example, in the illustration of FIG. 1, terminal apparatuses 3-1, 3-2, 3-3, . . . , 3-n are shown. Further, as shown in FIG. 2B, the terminal apparatus 3 includes a communication unit 31, a storage unit 32, a controller 33, a display unit 34, and an input unit 35, and these components are electrically connected via a communication bus 30 inside the terminal apparatus 3. Descriptions of the communication unit 31, the storage unit 32 and the controller 33 are the same as those of the respective units in the server apparatus 2, and are therefore omitted.

The display unit 34 may be included in a housing of the terminal apparatus 3, or may be attached thereto externally. The display unit 34 displays a screen of a graphical user interface (GUI) that can be operated by a user. For example, this displaying is preferably implemented by using different display devices, such as a CRT display, a liquid crystal display, an organic EL display, or a plasma display, depending on the type of the terminal apparatus 3.

The input unit 35 may be included in the housing of the terminal apparatus 3 or may be attached thereto externally. For example, the input unit 35 may be implemented as a touchscreen integrated with the display unit 34. If it is a touchscreen, the user can input operations such as tapping, swiping, and the like. Of course, instead of a touchscreen, switch buttons, a mouse, a keyboard and the like may be adopted. In other words, the input unit 35 receives operation inputs performed by the user. This input is transferred as an instruction signal to the controller 33 via the communication bus 30, and the controller 33 may perform predetermined control or computation as needed. Furthermore, the input unit 35 may include an imaging unit (so-called built-in camera).

### 2. Overview of Theory

Next, a theory related to information processing according to one embodiment will be outlined.

In general, in order to speed up program execution, it is common to utilize the parallelism and regularity of processing included in a program. Parallelism of processing is frequently included in processing of matrices and vectors, which are widely used in multimedia processing and machine learning, and regularity of processing is frequently included in processing of sequences such as Fibonacci sequences and difference sequences, as well as in search operations for arrays and character strings.

As an instruction that extracts parallelism and increases the amount of computation per control, SIMD instructions, vector instructions, and the like are adopted in many instruction set architectures. The SIMD instructions store a large amount of data having parallelism in a register by dividing a single register into a plurality of data widths. The vector instructions store a large amount of data having parallelism in a register by using a plurality of registers. Furthermore, by providing execution units and pipeline units that perform parallel processing in the backend, efficient processing utilizing parallelism becomes possible.

In an instruction set architecture that adopts SIMD instructions and vector instructions, a logical register is specified as a source operand; however, it is considered that more efficient extraction of parallelism is possible by adopting a distance-specification format. The distance-specification format is a format in which a distance, indicating how many instructions prior to the current instruction are to be referenced, is specified as a source operand. In such a format, when performing parallel processing or regular processing, the distances of source operands in the instruction sequence are arranged regularly. Therefore, simply introducing an instruction that repeats with regularity enables parallel processing of data.

Accordingly, it is preferable that, a new instruction called a repeat instruction used in an instruction set architecture of the distance-specification format, and an execution method suitable for the repeat instruction are required. The repeat instruction repeats the immediately following instruction according to a predetermined regularity. It becomes possible to group instruction sequences having parallelism or regularity by using the repeat instruction. That is, not only can parallelism be extracted in the same manner as with SIMD instructions, vector instructions, or the like, but regularity that is difficult to extract with SIMD instructions, vector instructions, or the like can also be extracted. Furthermore, as an addition of instructions, the addition of a new register is not required, thereby realizing a concise instruction set. This prevents the decoding process from becoming complicated and furthermore provides high extensibility as an instruction set.

By using repeat instructions, it is possible to execute parallel processing by regarding data arranged vertically on a register as one large vector. Such an execution method is newly named a vertical vector execution method. In SIMD instructions and vector instructions, a plurality of pieces of data are stored in dedicated wide registers, and those data arranged continuously in the horizontal direction are processed in parallel. In contrast, when using repeat instructions, it is guaranteed that data on the register are continuously arranged in the vertical direction, so that it is possible to extract large parallelism by using a plurality of registers without using a complicated mechanism such as register grouping introduced in vector instructions. In addition, further performance improvement can be expected by introducing an efficient execution unit that processes data arranged in the vertical direction in parallel.

### 3. Information Processing Method

Next, an information processing method according to one embodiment will be described.

### 3.1 Overview

An information processing method according to one embodiment is an information processing method that is executed by a processor (for example, the controller 23) based on an instruction set. Such an instruction set includes an instruction that uses, as an operand, a relative position that refers to a past execution result.

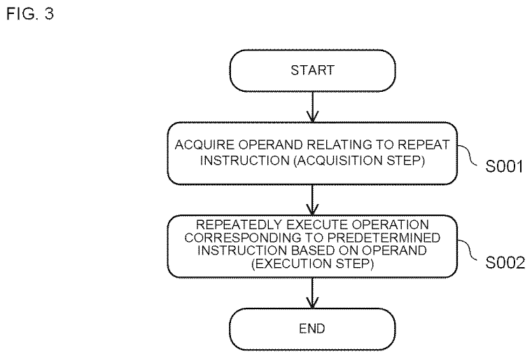

FIG. 3 is a flowchart showing an overview of the information processing method according to one embodiment. As illustrated, the information processing method includes the following steps. In an acquisition step, operands relating to a repeat instruction included in the instruction set are acquired (Step S001). In an execution step, an operation corresponding to a predetermined instruction is repeatedly executed based on the acquired operands (Step S002). Here, the operands include a first operand indicating the number of repetitions of the predetermined instruction, and a second operand indicating a stride of a register of the predetermined instruction.

The present disclosure may also be provided as an information processing architecture, and this information processing architecture includes a processor configured to execute a program so as to perform each of steps of the information processing method.

Furthermore, the present disclosure may also be provided as a program for causing at least one computer to execute each of steps of the information processing method.

According to such various aspects, it is possible to handle processing that utilizes data-level parallelism handled by SIMD instructions and vector instructions. In addition, due to the simplicity of adding only one instruction, it is possible to suppress the complexity of decoding. Furthermore, as the hardware scales, there is no need to add new instructions, resulting in high extensibility. Moreover, dedicated registers such as vector registers are no longer required. Furthermore, since it is easy to continuously allocate physical registers to instructions, efficient processing of large amounts of data can be achieved by devising the backend.

### 3.2 Specific Examples

The specific examples shown below may fall within the scope defined in the aforementioned overview. Incidentally, in conventional information processing methods, when handling a variable during execution of a program, it is common to read out a value stored in the variable by specifying an address of a register. On the other hand, in the information processing method according to one embodiment, a result of a calculation executed N steps before is read out.

### (Format of Repeat Instruction)

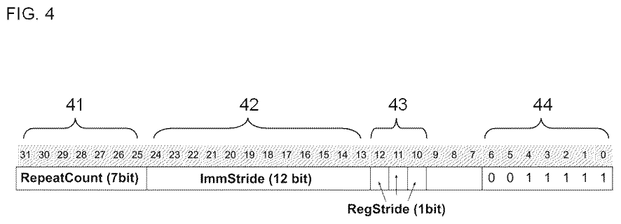

FIG. 4 is a schematic diagram showing an example of an instruction format of a repeat instruction. As shown in Field 41, in a repeat count (RepeatCount) that is an example of a first operand, a 7-bit immediate value is adopted. Preferably, the instruction required as the repeat instruction is a single instruction, “REP.”

Even in a case where the register width is expanded, no addition of new instructions is necessary, resulting in high extensibility.

As shown in Field 42, in an immediate stride value (ImmStride) that is an example of a third operand, a 12-bit immediate value is adopted. In other words, the operands further include a third operand indicating an immediate stride value in a predetermined instruction. According to such an aspect, the immediate value of the register can be defined in the repeat instruction, thereby enabling realization of more diverse opcodes. Furthermore, as shown in Field 43, in a stride of a register that is an example of the second operand, it is preferable that the value is set to zero or one, and one bit is allocated for each. In addition, since the maximum number of source registers that a single instruction can have is three, a total of three bits is provided.

Then, Field 44 is a field indicating that the first zero to six bits represent a repeat instruction. Preferably, since only the REP instruction exists as the repeat instruction, it is configured to be decodable as the REP instruction by checking Field 44.

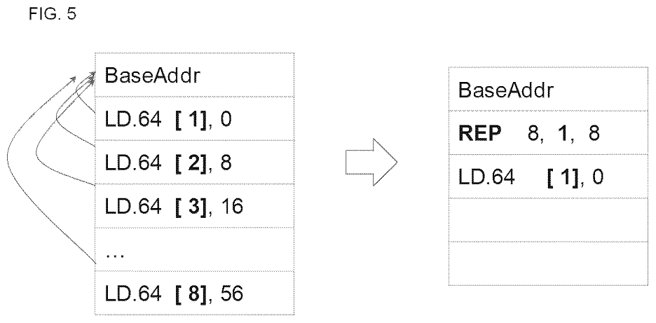

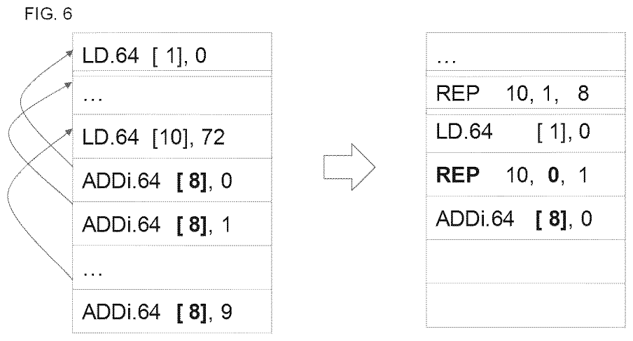

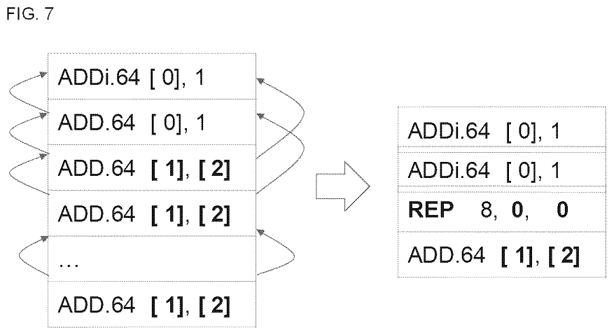

FIG. 5 shows an example of source code using a repeat instruction, and particularly shows a base reference that refers to the same register in each line of an instruction sequence. FIG. 6 shows an example of source code using a repeat instruction, and particularly shows an incremental parallel reference in which the stride of the register is zero and the reference distance is greater than or equal to the repeat count. FIG. 7 shows an example of source code using a repeat instruction, and particularly shows an incremental dependent reference in which the stride of the register is zero and the reference distance is less than the repeat count.

In each drawing, the embodiment shown on the left side of the arrow is an example in which a predetermined instruction is described without using the repeat instruction, and the embodiment shown on the right side of the arrow is an example in which a predetermined instruction is described by using the repeat instruction. A predetermined instruction other than the repeat instruction (hereinafter referred to as a basic instruction) includes two operands: [n] and an immediate value. Here, [n] means specifying the execution result of the instruction executed n instructions before (where n is a natural number satisfying n≤127). For example, [1] specifies the execution result of the instruction executed one instruction before, and [2] specifies the execution result of the instruction executed two instructions before. As examples of basic instructions, LD, ADD, ST, and the like are illustrated, but details are omitted. The repeat instruction has, as operands, a repeat count that is an example of the first operand, a stride of the register that is an example of the second operand, and an immediate stride value that is an example of the third operand. In the figures, the repeat instruction is shown as REP.

For example, referring to the embodiment on the left side of FIG. 5, the value of [n] increases by one in each line of the instruction sequence, that is, it can be understood that the same register is referenced in each line of the instruction sequence. When using the repeat instruction, it may be described as “REP 8, 1, 8” or the like. That is, in such a case, the repeat count is eight, the stride of the register is one, and the immediate stride value is eight. The repeat instruction is preferably described immediately before the basic instruction (for example, LD.64) to be repeatedly executed.

In other words, as shown in FIG. 5, the value of the second operand exemplified as the stride of the register is one. According to such an aspect, extraction of parallelism becomes possible, and it can be applied to load instructions, store instructions, vector-scalar operations, and the like.

In addition, in FIG. 6 and FIG. 7, the value of [n] is constant in each line, and it can be understood that registers having the same reference distance are successively referenced in each line of the instruction sequence.

Here, in the case of FIG. 6, the value of the second operand exemplified as the stride of the register is zero, and the reference distance defined by the relative position to be referenced may be greater than or equal to the value of the first operand. Considering that the reference distance is greater than or equal to the repeat count, mutual references within the repeat instruction sequence do not occur. Such a case is referred to as an incremental parallel reference. The incremental parallel reference is often used for vector-to-vector operations. Preferably, in the case of incremental parallel reference, the instruction sequence referenced by the operand is also grouped as a repeat instruction. That is, according to such an aspect, extraction of parallelism becomes possible, and it can be applied to vector-to-vector operations, and the like.

On the other hand, as shown in FIG. 7, the value of the second operand exemplified as the stride of the register is zero, and the reference distance defined by the relative position to be referenced may be less than the value of the first operand. That the reference distance is less than the repeat count means that at least one of the repeat instruction sequences becomes a reference target of the operand, resulting in the occurrence of dependency within the repeat instruction sequence. Such a case is referred to as an incremental dependent reference. The incremental dependent reference is used for reduction processing such as obtaining the sum or product of elements in a vector, and for calculations of complex sequences. For example, in the case of reduction processing, an instruction that generates an initial value needs to be inserted at the beginning of the repeat instruction sequence. According to such an aspect, extraction of regularity becomes possible, and it can be applied to reduction processing such as obtaining the sum or product of elements in a vector, and to calculations of complex sequences such as Fibonacci sequences and difference sequences.

Preferably, the opcode in the information processing has 32 bits. According to such an aspect, it is possible to appropriately set the fields including each operand.

Preferably, in the execution step, the controller 23 executes the operation by unrolling the repetitions defined by the repeat instruction. According to such an aspect, it is possible to define a repetitive processing with a concise instruction, thereby improving the convenience of coding.

### (Vertical Vector Execution Method)

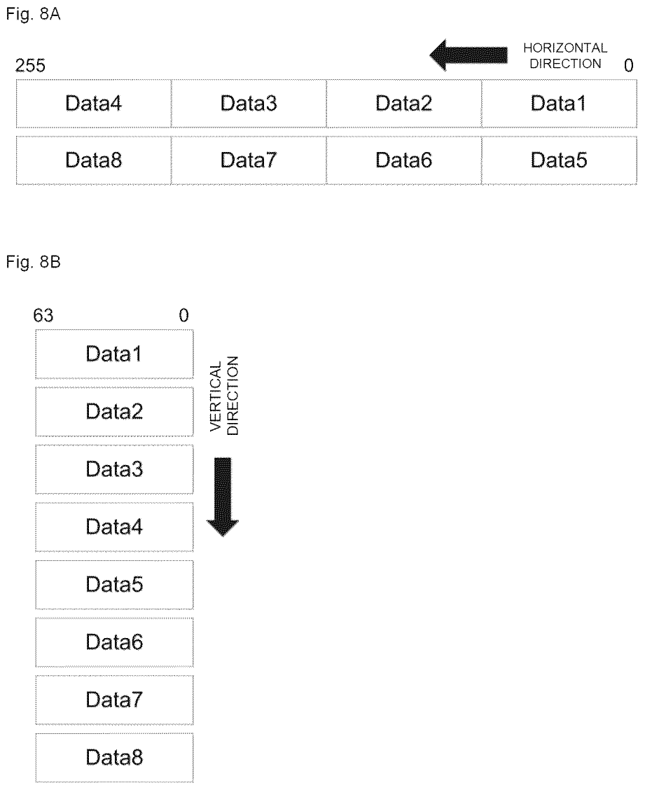

FIG. 8A and FIG. 8B are schematic diagrams for explaining a vertical vector execution method. FIG. 8A shows a conventional general vector instruction, and FIG. 8B shows a vertical vector execution method. By using registers extending in the distance direction (vertical direction) when executing the repeat instruction, dedicated registers and register grouping become unnecessary. As shown in FIG. 8A, in general vector instructions, data are packed in the horizontal direction into a plurality of dedicated registers called vector registers to collect the data into one place. Furthermore, in order to specify a plurality of registers with a single instruction, a register grouping mechanism is required. In contrast, in the information processing according to one embodiment, registers are allocated in the order fetched according to the repeat instruction, so that data are arranged continuously in the vertical direction as shown in FIG. 8B. The execution method using such a data storage method is referred to as a vertical vector execution method. In the vertical vector execution method, parallel processing is possible without using a complicated mechanism such as dedicated registers or register grouping.

In other words, the register includes a plurality of registers, and a plurality of pieces of data processed in the information processing method are stored in the plurality of registers along a direction perpendicular to a data sequence. According to such an aspect, it is possible to realize pipeline processing in the backend similarly to vector instructions. Furthermore, unlike vector instructions, hardware or instructions for retaining information on which registers to group become unnecessary.

### (Compiler for Code Including Repeat Instruction)

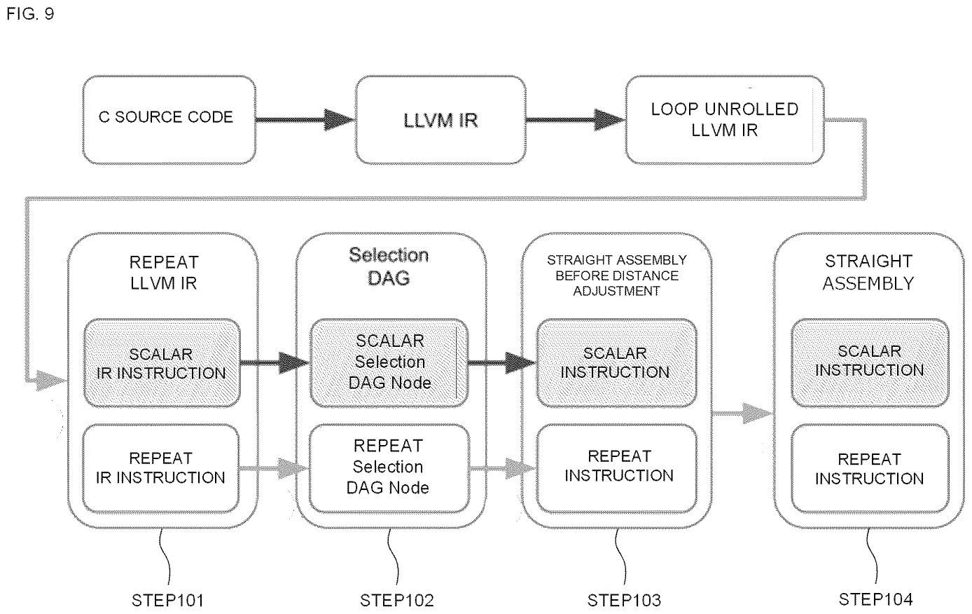

Next, a compiler for code including a repeat instruction will be described. A compiler that outputs machine code for realizing the above-described information processing method may be implemented. FIG. 9 is a schematic diagram showing a flow of compilation. Hereinafter, Steps S101 to S104 in this figure will be described.

### (Step S101)

First, the controller 23 analyzes the instruction sequence while scanning a graph of reference relationships between the instructions, and at that time, by adding repeat information to the instructions, a plurality of repeatable instructions are grouped into a single repeat instruction. This grouping operation will hereinafter be referred to as grouping in an instruction sequence. When adding repeat information to an IR instruction, it is preferable to use the metadata mechanism of LLVM to add metadata including repeat information “!rep”, thereby outputting it as a single repeat IR instruction.

### (Step S102)

Next, a repeat SelectionDAG Node is newly introduced to transmit the repeat information added to the repeat IR instruction to the compiler backend. The controller 23 uses a SelectionDAG Node that has already been implemented in LLVM as a scalar SelectionDAG Node and generates a corresponding repeat SelectionDAG Node. When copy information is added to an instruction, it is preferable that a copy repeat SelectionDAG Node of the same type as the repeat Selection DAG Node is created. For example, a repeat copy SelectionDAG Node corresponding to SHL is prefixed with “CR” and called CRSHL.

### (Step S103)

The controller 23 converts the SelectionDAG Node retaining the repeat information into a repeat instruction as assembly. At this time, the controller 23 outputs the repeat instruction as a single instruction. That is, when it is desired to repeat a store instruction called ST.64, it is preferable to output it as an instruction called RST.64 that also takes repeat information as an operand. In addition, the controller 23 also converts the copy repeat SelectionDAG Node into a repeat instruction in the same manner. For example, if it is a CRSHL Node, it is converted into an instruction such as “CRSLLi.64.”

### (Step S104)

The controller 23 converts a copy repeat instruction into “copy instruction+repeat instruction.”

Specifically, an instruction called RMOV is used for copying the instruction, and it is converted into “RMOV+REP+instruction to be repeated.”
Thereafter, since the distance between instructions has been shifted due to outputting the repeat instruction in assembly, the controller 23 adjusts the source operand distance. Although the repeat instruction is output as a single instruction in assembly, in practice, the number of instructions corresponding to the repeat count is executed. Accordingly, RP is incremented by the repeat count, rather than by one, before and after the repeat instruction. When the repeat instruction refers to another repeat instruction sequence, it is preferable that the first instruction of the sequence be referenced, and when a scalar instruction refers to a repeat instruction sequence, it is preferable that the last instruction of the sequence be referenced. That is, the controller 23 adjusts the distance between instructions in consideration of the above. The foregoing is an example of a compilation procedure.
In other words, further in a compilation step, object code corresponding to the processor is generated from the source program so as to include a repeat instruction. According to such an aspect, it is possible to implement a compiler capable of compiling object code including a repeat instruction.

### Others

The compiler described in one embodiment may be stored in the storage unit 22 of the server apparatus 2, and the compiler may be configured to be available from the terminal apparatus 3 via the network 11. In such a case, it is preferable that a user who uses the terminal apparatus 3 performs coding that makes full use of repeat instructions by using his or her own terminal apparatus 3, and machine code is generated through the compiler to produce a desired program.

Further, the present disclosure may be provided by each of the following embodiments.
(1) An information processing method based on an instruction set, the instruction set including an instruction that uses, as an operand, a relative position that refers to a past execution result, the method comprising: an acquisition step of acquiring operands relating to a repeat instruction included in the instruction set; and an execution step of repeatedly executing, based on the acquired operands, an operation corresponding to a predetermined instruction; wherein the operands include: a first operand indicating a number of repetitions of the predetermined instruction, and a second operand indicating a stride of a register of the predetermined instruction.

According to such an aspect, it is possible to handle processing that utilizes data-level parallelism handled by SIMD instructions and vector instructions. In addition, due to the simplicity of adding only one instruction, it is possible to suppress the complexity of decoding. Furthermore, as the hardware scales, there is no need to add new instructions, resulting in high extensibility. Moreover, dedicated registers such as vector registers are no longer required. Furthermore, since it is easy to continuously allocate physical registers to instructions, efficient processing of large amounts of data can be achieved by devising the backend.
(2) The information processing method according to (1), wherein: the execution step includes executing the operation by unrolling the repetitions defined by the repeat instruction.

According to such an aspect, it is possible to define a repetitive processing with a concise instruction, thereby improving the convenience of coding.
(3) The information processing method according to (1) or (2), wherein: a value of the second operand is one.

According to such an aspect, extraction of parallelism becomes possible, and it can be applied to load instructions, store instructions, vector-scalar operations, and the like.
(4) The information processing method according to (1) or (2), wherein: a value of the second operand is zero, and the relative position to be referenced defines a reference distance that is greater than or equal to a value of the first operand.

According to such an aspect, extraction of parallelism becomes possible, and it can be applied to vector-to-vector operations, and the like.
(5) The information processing method according to (1) or (2), wherein: a value of the second operand is zero, and the relative position to be referenced defines a reference distance that is less than a value of the first operand.

According to such an aspect, extraction of regularity becomes possible, and it can be applied to reduction processing such as obtaining the sum or product of elements in a vector, and to calculations of complex sequences such as Fibonacci sequences and difference sequences.
(6) The information processing method according to any one of (1) to (5), wherein: the operands further include a third operand indicating an immediate stride value in the predetermined instruction.

According to such an aspect, the immediate value of the register can be defined in the repeat instruction, thereby enabling realization of more diverse opcodes.
(7) The information processing method according to any one of (1) to (6), wherein: the information processing method uses an opcode that is 32 bits long.

According to such an aspect, it is possible to appropriately set the fields including each operand.
(8) The information processing method according to any one of (1) to (7), wherein: the register includes a plurality of registers, and a plurality of pieces of data processed in the information processing method are stored in the plurality of registers along a direction perpendicular to a data sequence.

According to such an aspect, it is possible to realize pipeline processing in the backend similarly to vector instructions. Furthermore, unlike vector instructions, hardware or instructions for retaining information on which registers to group become unnecessary.
(9) The information processing method according to any one of (1) to (8), further comprising: a compilation step of generating object code corresponding to a processor from a source program so as to include the repeat instruction.

According to such an aspect, it is possible to implement a compiler capable of compiling object code including a repeat instruction.
(10) An information processing architecture, comprising a processor configured to execute a program so as to perform each of steps of the information processing method according to any one of (1) to (9).

According to such various aspects, it is possible to handle processing that utilizes data-level parallelism handled by SIMD instructions and vector instructions. In addition, due to the simplicity of adding only one instruction, it is possible to suppress the complexity of decoding. Furthermore, as the hardware scales, there is no need to add new instructions, resulting in high extensibility. Moreover, dedicated registers such as vector registers are no longer required. Furthermore, since it is easy to continuously allocate physical registers to instructions, efficient processing of large amounts of data can be achieved by devising the backend.
(11) A program for causing at least one computer to execute each of steps of the information processing method according to any one of (1) to (9).

According to such various aspects, it is possible to handle processing that utilizes data-level parallelism handled by SIMD instructions and vector instructions. In addition, due to the simplicity of adding only one instruction, it is possible to suppress the complexity of decoding. Furthermore, as the hardware scales, there is no need to add new instructions, resulting in high extensibility. Moreover, dedicated registers such as vector registers are no longer required. Furthermore, since it is easy to continuously allocate physical registers to instructions, efficient processing of large amounts of data can be achieved by devising the backend.

### Of Course, the Present Disclosure is not Limited to the Above Aspects

Finally, various embodiments according to the present disclosure have been described, but these are presented as examples and are not intended to limit the scope of the invention. Novel embodiments can be implemented in various other forms, and various omissions, replacements, and modifications can be made within the scope of the spirit of the invention. The embodiments and its modifications are included in the scope and the spirit of the invention and are included in the scope of the invention described in claims and the equivalent scope thereof.

What is claimed is:

1. An information processing method based on an instruction set, the instruction set including an instruction that uses, as an operand, a relative position that refers to a past execution result, the method being executed by a processor reading a program, the method comprising:
acquiring operands relating to a repeat instruction included in the instruction set; and
repeatedly executing, based on the acquired operands, an operation corresponding to a predetermined instruction; wherein the operands include:
a first operand indicating a number of repetitions of the predetermined instruction, and
a second operand indicating a stride of a register of the predetermined instruction.

2. The information processing method according to claim 1, wherein:
the executing includes executing the operation by unrolling the repetitions defined by the repeat instruction.

3. The information processing method according to claim 1, wherein:
a value of the second operand is one.

4. The information processing method according to claim 1, wherein:
a value of the second operand is zero, and
the relative position to be referenced defines a reference distance that is greater than or equal to a value of the first operand.

5. The information processing method according to claim 1, wherein:
a value of the second operand is zero, and
the relative position to be referenced defines a reference distance that is less than a value of the first operand.

6. The information processing method according to claim 1, wherein:
the operands further include a third operand indicating an immediate stride value in the predetermined instruction.

7. The information processing method according to claim 1, wherein:
the information processing method uses an opcode that is 32 bits long.

8. The information processing method according to claim 1, wherein:
the register includes a plurality of registers, and
a plurality of pieces of data processed in the information processing method are stored in the plurality of registers along a direction perpendicular to a data sequence.

9. The information processing method according to claim 1, the method being executed by a processor reading a program, and further comprising:
generating object code corresponding to a processor from a source program so as to include the repeat instruction.

10. An information processing architecture, comprising a processor configured to execute a program so as to perform each of steps of the information processing method according to claim 1.

11. A non-transitory computer-readable storage medium storing a program for causing at least one computer to execute each of steps of the information processing method according to claim 1.
